(19) United States
(12) Patent Application Publication
(10) Pub. No.: US 2018/0330887 A1
(43) Pub. Date: Nov. 15, 2018

(54) Electrolytic Capacitor with Safety Vent

(71) Applicant: EPCOS AG, Munich (DE)

(72) Inventors: Krisztián Elekes, Káld (HU); Róbert Bösze, Tanakajd (HU); Ottó Klug, Szombathely (HU); László Gál, Magyarkanizsa (RS)

(21) Appl. No.: 15/777,181

(22) PCT Filed: Nov. 15, 2016
(86) PCT No.: PCT/EP2016/077746

§ 371 Date: May 17, 2018

(30) Foreign Application Priority Data
Nov. 17, 2015 (DE) 10 2015 119 844.4

(51) Int. Cl. H01G 9/12; H01G 9/10; H01G 9/008; H01G 9/035

(52) U.S. Cl. CPC H01G 9/12; H01G 9/035; H01G 9/008; H01G 9/10

(57) ABSTRACT

An electrolytic capacitor with a safety vent is disclosed. In an embodiment the electrolytic capacitor includes a case, a capacitor element mounted in the case and a safety vent for enabling pressure relief, wherein the safety vent is located at least partially inside a hole of the capacitor element.

This patent application is a national phase filing under section 371 of PCT/EP2016/077746, filed Nov. 15, 2016, which claims the priority of German patent application 10 2015 119 844.4, filed Nov. 17, 2015, each of which is incorporated herein by reference in its entirety.

### TECHNICAL FIELD

The present invention relates to an electrolytic capacitor with a safety vent. The safety vent is provided for enabling pressure relief and, thereby, prevents an uncontrolled explosion of the capacitor, for example.

### SUMMARY OF THE INVENTION

Embodiments of the present invention provide an electrolytic capacitor with an improved safety vent.

In one aspect, embodiments of the present invention relate to an electrolytic capacitor comprising a case and a capacitor element mounted in the case. The case may have the shape of a can. The capacitor element may be a wound element. The capacitor element may comprise foils, in particular aluminum foils. The capacitor element may be impregnated by an electrolyte, in particular a liquid electrolyte.

The electrolytic capacitor comprises a safety vent for enabling pressure relief.

During operation, the pressure inside the capacitor may increase, in particular in case of an overload. The safety vent may be configured to burst when the pressure approaches a critical value. Thereby, an uncontrolled explosion of the capacitor may be prevented.

Additionally or alternatively, the safety vent may enable gradual pressure relief. In particular, a continuous diffusion of gas may be enabled. Gradual pressure relief may be enabled long before a critical value is reached. During gradual pressure relief, the safety vent may remain intact.

The safety vent may comprise an elastic material. As an example, the safety vent may comprise a rubber or silicone material. As an example, the safety vent is plugged in the case, for example, in a hole in the case.

The safety vent may comprise a membrane. Thereby, gradual diffusion of the gas generated in the capacitor is enabled.

According to an embodiment, the safety vent is located at least partially inside a hole in the capacitor element. The hole may extend along a central axis of the capacitor element. The hole may result from winding the foils of the capacitor element around a central axis. Accordingly, the safety vent may be encircled by foils of the capacitor element.

The electrolytic capacitor may comprise terminals for electrically contacting the capacitor. The terminals are located at a first side of the capacitor. The terminals may be screw-type terminals. In other embodiments, the terminals may be configured in a snap-in style, for example.

In an embodiment, the safety vent is configured such that pressure relief is enabled through the second side of the capacitor, wherein the second side is opposite to the first side. Accordingly, the safety vent enables gas to leave the case through the second side. In an embodiment, the safety vent is located nearer to the second side of the capacitor than to the first side of the capacitor.

By enabling a pressure relief at a side remote from the first side, the risk for contamination of the terminals and/or other components such as a printed circuit board or a bus bar can be reduced and the operational life be prolonged. Such a contamination may occur due to electrolyte leaking out of the case after a burst of the safety vent.

In an embodiment, the capacitor is mounted such that the side through which pressure relief is enabled does not point downwards. As an example, the side points upwards or horizontally.

In this case, electrolyte can be efficiently prevented from flowing outwards after a burst of the safety vent. In addition to that, also a contamination of the safety vent by electrolyte during normal operation of the capacitor may be prevented. This may ensure that gradual diffusion is maintained when the safety vent is still intact.

In an embodiment, the capacitor is mounted terminal-down. Accordingly, the terminals point downwards. In a further embodiment, the capacitor is mounted with the terminals arranged horizontally. In an even further embodiment, the capacitor is mounted terminal-up.

In an embodiment, the safety vent is configured such that pressure relief is enabled through the first side of the capacitor. This may be particularly useful when the capacitor is mounted terminal-up.

The capacitor may be mounted at a mounting member. The mounting member may also provide the electrical connection of the capacitor. As an example, the mounting member may comprise a printed circuit board or a bus bar. Alternatively, the electrical connection may be provided by a member additional to the mounting member. The capacitor may be mounted such that the first side is adjacent to the mounting member. Alternatively, the capacitor may be mounted such that the second side is adjacent to the mounting member. Alternatively, the capacitor may be mounted such that its lateral side is adjacent to the mounting member.

The capacitor may comprise a cover member for sealing the case. The cover member may be located at the first side of the capacitor. The terminals may be lead through the cover member. The cover member may comprise an elastic material, in particular a rubber material. The cover member may be an element plugged in the case.

In an embodiment, the cover member is free from any safety vent. In an alternative embodiment, a safety vent may be at least partially located in the cover member.

In an embodiment, the capacitor may comprise a centering member extending into the hole of the capacitor element. The safety vent may be located in the centering member. The centering member may be provided for centering the capacitor element in the case.

The centering member may be located near the second side of the capacitor. As an example, the centering member may be formed integral with the second side of the capacitor. The centering member may be formed integral with a can bottom. As an example, the centering member may be formed as a hole in the second side. The centering member may extend in a direction towards the core of the capacitor. The centering member may comprise a metal. The centering member may alternatively or additionally be located near the first side of the capacitor, e.g., beneath a cover member.

The centering member may be configured such that contact of the electrolyte with the safety vent is prevented. In particular, the centering member may separate the safety vent from the capacitor element and from the electrolyte.

The centering member may have a tubular shape. The safety vent may be located in the tube cavity. The safety vent may seal the centering member such that electrolyte is prevented from leaking out of the capacitor during normal operation of the device, in particular as long as the safety vent is intact. The centering member may be open towards the core of the capacitor.

In an embodiment, the safety vent is recessed in the capacitor. In particular, the safety vent is located at a distance from the outer surfaces of the first and second sides. Thereby, a contamination of the outer sides of the capacitor by electrolyte leakage may be prevented.

As an example, a cavity may exist between the safety vent and a side of the capacitor, in particular the outer surface of the side through which pressure relief is enabled. The cavity may be fillable with electrolyte. In this case, the cavity may take up an amount of electrolyte leaking through the safety vent.

In an embodiment, the capacitor comprises several safety vents. As an example, a first safety vent may enable pressure relief through the first side and a second safety vent may enable pressure relief through the second side of the capacitor.

Depending on the mounting orientation of the capacitor, at least one of the safety vents may enable pressure relief through a side oriented upwards or horizontally. Thereby, gradual pressure relief may be ensured. The further safety vent may enable pressure relief through a side pointing downwards. In some embodiments, one of the safety vents may be located inside the hole of the capacitor element. The further safety vent may be located completely outside the capacitor element. The further safety vent may be located in the cover member, for example. Alternatively, both safety elements may be at least partially located inside the hole of the capacitor element.

In an embodiment, the capacitor comprises a stud. The stud may be located at the second side of the capacitor. The stud may be threaded. The stud may serve for mounting and, in particular, fixing the capacitor to a mounting member.

The safety vent may be located in the stud, in particular in a portion of the stud which extends to the core of the capacitor. The stud may be integrally formed with a side of the capacitor and/or integrally formed with a centering member.

According to a further aspect of the present invention, an electrolytic capacitor comprises a case, a capacitor element mounted in the case and a safety vent enabling gradual pressure relief. The capacitor comprises terminals located at a first side, wherein the safety vent enables pressure relief through an opposite second side of the capacitor. The capacitor may comprise any functional and structural characteristics of the capacitor described above. As an example, the safety vent may comprise a membrane. The safety vent may be located in a hole of the capacitor element.

According to a further aspect of the present invention, a method of operating an electrolytic capacitor comprising a safety vent is disclosed. The safety vent may enable gradual pressure relief through a side of the capacitor. The capacitor may be operated in an orientation, where the side through which pressure relief is enabled does not point downwards. As examples, the side points upwards or horizontally. The capacitor may comprise any functional and structural characteristics of the capacitor described above. As an example, the safety vent may comprise a membrane. The safety vent may be located in a hole of the capacitor element.

According to a further aspect of the present invention, a mounting assembly is provided, the mounting assembly comprising at least one of the capacitors described above and a mounting member. The capacitor is mounted at the mounting member. In an embodiment, the mounting member may also enable an electrical connection of the capacitor. In an embodiment, the mounting member may not serve to electrically connect the capacitor. The capacitor and the mounting member may comprise any functional and structural characteristics of the capacitor and mounting member as described above.

The present disclosure comprises several embodiments and aspects of an invention. Every feature described with respect to one of the capacitors, the mounting assembly and or the method are also disclosed herein with respect to the respective other embodiments and aspects, even if the respective feature is not explicitly mentioned in the context of the specific embodiment or aspect.

### BRIEF DESCRIPTION OF THE DRAWINGS

Further features, refinements and expediencies become apparent from the following description of the exemplary embodiments in connection with the figures.

FIG. 1 shows a schematic cross sectional view of a capacitor according to a first embodiment,

FIG. 2 shows a view on a second side of the capacitor according to the first embodiment,

FIG. 3 shows a view on a first side of the capacitor according to the first embodiment.

FIG. 4 shows a schematic cross sectional view of a capacitor according to a second embodiment.

Similar elements, elements of the same kind and identically acting elements may be provided with the same reference numerals in the figures.

### DETAILED DESCRIPTION OF ILLUSTRATIVE EMBODIMENTS

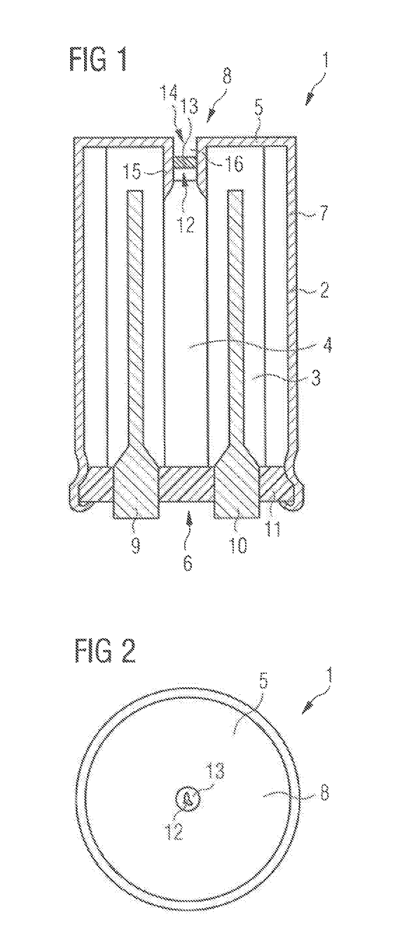

FIG. 1 shows an electrolytic capacitor 1. The capacitor 1 comprises a case 2 and a capacitor element 3 mounted in the case 2. The capacitor element 3 comprises a wound shape. The capacitor element 3 has a cylindrical shape with a hole 4 extending along its central axis. The capacitor element 3 may comprise foils, in particular aluminum foils. The capacitor element 3 is impregnated with a liquid electrolyte.

The case 2 may have the shape of a circular cylinder. The case 2 may comprise a metal. As an example, the case 2 may comprise aluminum. The case 2 may have the shape of a can.

The capacitor 1 comprises a first side 6, a lateral side 7 and a second side 8. The second side 8 is opposite to the first side 6. The second side 8 may be formed by a bottom 5 of the case 2. The bottom 5 may comprise a metal. The bottom 5 may be integrally formed with the lateral side 7.

At the first side 6, the capacitor 1 comprises terminals 9, 10 for electrically connecting the capacitor. The terminals 9, 10 may be configured as screw-type terminals. The capacitor 1 may be configured to be mounted terminal-down, i.e., such that the terminals 9, 10 point towards the Earth's center. Alternatively, the capacitor 1 may be mounted horizontally, i.e., with the terminals 9, 10 pointing in a horizontal direction. Alternatively, the capacitor 1 may be mounted terminal-up.

The capacitor 1 may be mounted at a mounting member (not shown). The mounting member may serve to fix the capacitor 1. Additionally, the mounting member may serve to electrically connect the terminals 9, 10. In this case, the mounting member may comprise a printed circuit board or a bus bar, for example.

At the first side 6, the case 2 is closed by a cover member 11. The cover member 11 may have the shape of a disc. The cover member 11 may seal the case 2. The cover member 11 may comprise a rubber material or another elastic material. The terminals 9, 10 are lead through the cover member 11.

The capacitor 1 comprises a safety vent 12. The safety vent 12 enables controlled pressure relief. During operation of the capacitor 1, gas generation and pressurization inside the capacitor 1 may occur, which may be caused by electrochemical reactions. The safety vent 12 may enable a discharge of the gas when the inner pressure approaches a critical value. Thereby, an uncontrolled explosion of the capacitor 1 may be prevented. As an example, the safety vent 12 may be designed to burst in case of a critical pressure.

Additionally or alternatively, the safety vent 12 may enable gradual diffusion of the gas to the ambient during the operation of the electrolytic capacitor 1. Thereby, the inner pressure may be gradually reduced. The safety vent 12 may comprise a membrane 13. The membrane 13 may comprise a rubber or silicone material. In particular, the safety vent 12 may comprise a thin rubber membrane. The membrane 13 may be permeable or semi-permeable for gas.

The safety vent 12 may be configured such that pressure relief is enabled through the second side 8 of the capacitor 1. In particular, pressure relief is enabled through a hole 14 in the bottom 5 of the case 2. The safety vent 12 is located at a smaller distance from the second side 8 than the first side 6 of the capacitor 1.

Such an arrangement of the safety vent 12 may be particularly beneficial in a mounting orientation of the capacitor 1 where the side through which pressure-relief is enabled points upwards. In case of pressure relief being enabled through the second side 8, this orientation corresponds to a terminal-down mounting orientation. This construction may be both beneficial in case of a burst of the safety vent 12 and for gradual pressure relief with the safety vent 12 being intact.

When the safety vent 12 is intact, this construction may prevent the safety vent 12 from being covered with electrolyte. When the safety vent 12 is located at a lower side of the capacitor 1, electrolyte may cover the safety vent 12 due to gravity and thus block diffusion. This may result in cumulative pressurization until the safety vent 12 burst. This phenomenon may reduce the efficiency of the operation of the safety vent 12. When the safety vent 12 is positioned at an upper side of the capacitor 1 it may be kept free from electrolyte such that gradual diffusion is maintained.

The capacitor 1 comprises a centering member 15 protruding at the second side 8 into the hole 4 of the capacitor element 3. The centering member 15 serves to center the capacitor element 3 in the case 2. The centering member 15 may be formed as a peg. The centering member 15 may be hollow. The centering member 15 may be integrally formed with the bottom 5 of the case 2.

The safety vent 12 is located in the centering member 15. Thereby the two functions of winding fixation and pressure relief can be combined. The centering member 15 separates the safety vent 12 from the capacitor element 3.

The safety vent 12 is located inside the hole 4 of the capacitor element 3. The safety vent 12 is encircled by the windings of the capacitor element 3. Accordingly, the safety vent 12 is located in the core of the capacitor 1.

The safety vent 12 is located at a distance from the bottom 5 of the case 2. In particular, the safety vent 12 is located in a recessed position relative to the bottom 5. Thereby, the safety vent 12, and, in particular the membrane 13 may be protected from mechanical damage.

As an example, a cavity 16 may exist between the safety vent 12 and the bottom 5. This may help to avoid electrolyte leaking to the outside of the capacitor 1. As an example, the cavity 16 may receive a small amount of electrolyte leaking out of the capacitor 1 after a burst of the safety vent 12. This may prevent the bottom 5 from being contaminated by the electrolyte.

With the disclosed safety vent 12, the capacitor 1 can be filled with an excess amount of electrolyte, which helps to provide stable electrical parameters. Thereby, parameter drift during long-term operational life can be avoided. As an example, a drying out of the windings may be prevented. In a standard capacitor, the electrolyte reservoir may be restricted in order to avoid free-flowing liquid electrolyte inside the capacitor and, thereby, prevent electrolyte leakage. With the improved safety vent 12, electrolyte leakage may be prevented also in case of a high amount of electrolyte.

In a further embodiment, the capacitor 1 may alternatively or additionally comprise a centering member located near the first side 6. As an example, the centering member may protrude from the cover member 11 into the hole 4 of the capacitor element 3. A safety vent may be additionally or alternatively located in the centering member near the first side 6.

When the capacitor 1 comprises two safety vents, wherein one of the safety vents is located near the first side 6 and the other one is located at the second side 8, gradual diffusion may always be ensured, at least through one of the safety vents. In particular, gradual diffusion may be ensured at any orientation of the capacitor. As an example, the capacitor 1 may comprise a safety vent 12 at the second side 8 as shown in FIG. 1 and a further safety vent located in the cover member 11. The further safety vent may also comprise a rubber or silicone material, in particular a membrane.

FIG. 2 shows a view on the second side 8 of the capacitor 1 according to FIG. 1 after a pressure relief test. The pressure relief test was conducted at reverse polarity according to the IEC-60384-1 (2008) standard. During this test, relatively fast gas generation takes place due to the reverse polarity. Thereby, a high pressure was generated inside the capacitor 1.

As can be seen in FIG. 2, the membrane 13 of the safety vent 12 has burst. The capacitor 1 was mounted terminal-down. The second side 8, in particular the bottom 5, is not covered by electrolyte.

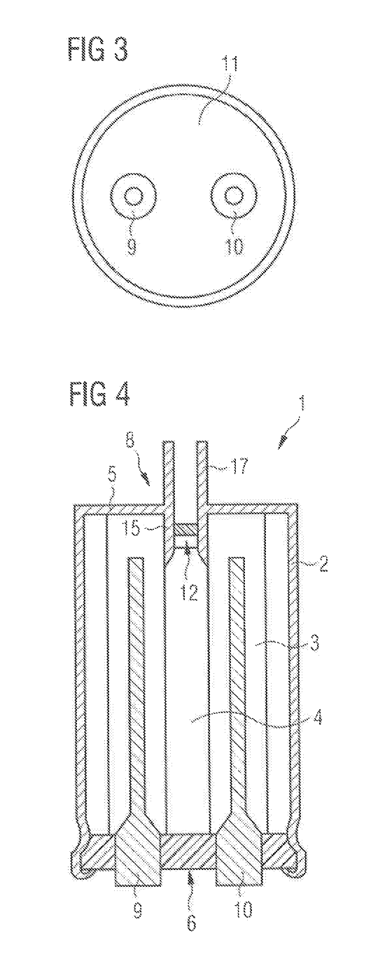

FIG. 3 shows a view on the first side 6 of the capacitor 1 according to FIG. 1 after the pressure relief test.

The first side 6, in particular the cover member 11, is not covered by electrolyte. In the shown embodiment, the cover member 11 is free from any safety vent.

FIG. 4 shows a further embodiment of a capacitor 1, which corresponds to the capacitor 1 shown in FIGS. 1, 2 and 3 but additionally comprises a stud 17 for mounting the capacitor 1. The stud 17 is located at the second side 8 of the capacitor 1.

The stud 17 may be threaded for screwing the capacitor 1 to a mounting member (not shown). The terminals 9, 10 may be connected to a printed circuit board or a bus bar, for example.

The stud 17 may be integrally formed with the bottom 5 and/or the centering member 15.

1-19. (canceled)

20. An electrolytic capacitor comprising:
a case;
a capacitor element mounted in the case; and
a safety vent for enabling pressure relief,
wherein the safety vent is located at least partially inside a hole of the capacitor element.

21. The electrolytic capacitor of claim 20, wherein the safety vent comprises a membrane.

22. The electrolytic capacitor of claim 20, further comprising terminals located at a first side of the electrolytic capacitor, wherein the safety vent is configured such that the pressure relief is enabled through an opposite second side of the electrolytic capacitor.

23. The electrolytic capacitor of claim 20, further comprising a cover member for sealing the case, wherein the cover member comprises an elastic material, and wherein the cover member is free from the safety vent.

24. The electrolytic capacitor of claim 20, wherein the electrolytic capacitor is configured such that an electrolyte in the electrolytic capacitor is not in contact with the safety vent.

25. The electrolytic capacitor of claim 20, further comprising a centering member extending into the hole of the capacitor element, wherein the safety vent is located in the centering member.

26. The electrolytic capacitor of claim 25, wherein the centering member is located near a first side or a second side of the electrolytic capacitor.

27. The electrolytic capacitor of claim 20, wherein the safety vent is recessed in the electrolytic capacitor.

28. The electrolytic capacitor of claim 20, wherein a cavity is located between the safety vent and an outer side of the electrolytic capacitor.

29. The electrolytic capacitor of claim 20, further comprising a stud, wherein the safety vent is located in the stud.

30. The electrolytic capacitor of claim 29, further comprising terminals at a first side of the electrolytic capacitor, wherein the stud is located at a second side of the electrolytic capacitor, and wherein the first side is opposite to the second side.

31. The electrolytic capacitor of claim 30, wherein the electrolytic capacitor comprises two safety vents.

32. The electrolytic capacitor of claim 31, wherein one of the safety vents is located in an elastic cover member for sealing the case at a first side and one of the safety vents is located inside a hole in the capacitor element near a second side of the electrolytic capacitor.

33. The electrolytic capacitor of claim 31, wherein one of the safety vents is located near a first side and one of the safety vents is located near a second side of the electrolytic capacitor, and wherein both safety vents are at least partially located inside a hole in the capacitor element.

34. A mounting assembly comprising:
the electrolytic capacitor according to claim 20; and
a mounting member, wherein the electrolytic capacitor is mounted at the mounting member.

35. An electrolytic capacitor comprising:
a case;
a capacitor element mounted in the case;
a safety vent for enabling gradual pressure relief; and
terminals located at a first side of the electrolytic capacitor,
wherein pressure relief is enabled through an opposite second side of the electrolytic capacitor.

36. A mounting assembly comprising:
the electrolytic capacitor according to claim 35; and
a mounting member, wherein the electrolytic capacitor is mounted at the mounting member.

37. A method of operating an electrolytic capacitor, wherein the electrolytic capacitor comprises a safety vent for enabling gradual pressure relief through a side of the electrolytic capacitor, the method comprising:
operating the capacitor in an orientation where the side does not point downwards.

38. The method of claim 37, wherein the side points upwards.

39. The method of claim 37, wherein the side points in a horizontal direction.
